(19) United States
(12) Patent Application Publication
(10) Pub. No.: US 2007/0074289 A1
(43) Pub. Date: Mar. 29, 2007

(54) Client side exploit tracking

(76) Inventor: Phil Maddaloni, Erie, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/237,291

(22) Filed: Sep. 28, 2005

(51) Int. Cl. G06F 12/14

(52) U.S. Cl. 726/23

(57) ABSTRACT

A system and method for managing pestware is described. In one embodiment the method includes monitoring the receipt of a file at the protected computer, monitoring processes created on the protected computer, identifying at least one of the processes as a process that is generated from the file, monitoring activity of the process, comparing activity of the at least one process with factors indicative of pestware and managing the file and the at least one process based upon the comparison of the activity of the at least one process with the factors.

### RELATED APPLICATIONS

The present application is related to the following commonly owned and assigned applications: Ser. No. 10/956,578, Attorney Docket No. WEBR-002/00US, entitled System and Method for Monitoring Network Communications for Pestware; application Ser. No. 10/956,573, Attorney Docket No. WEBR-003/00US, entitled System and Method For Heuristic Analysis to Identify Pestware; application Ser. No. 10/956,574, Attorney Docket No. WEBR-005/00US, entitled System and Method for Pestware Detection and Removal; application Ser. No. 11/104,202; application no. Ser. No. (11/105,978), Attorney Docket No. WEBR-013/00US, entitled System and Method for Scanning Obfuscated Files for Pestware filed Apr. 14, 2005; application Ser. No. 11/105,977, Attorney Docket No. WEBR-014/00US, entitled: System and Method for Scanning Memory for Pestware Offset Signatures filed Apr. 14, 2005; application Ser. No. 11/106,122 Attorney Docket No. WEBR-018/00US, entitled System and Method for Scanning Memory for Pestware, filed Apr. 14, 2005; application no. (unassigned) Attorney Docket No. WEBR-029/00US entitled System and Method for Removing Pestware in System-Level Processes and Executable Memory. Each of which is incorporated by reference in their entirety.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect some pestware, but many variations of pestware are difficult to detect with typical techniques. For example, pestware running in memory of a computer is often difficult to detect because it is disguised in such a way that it appears to be a legitimate process that is dependent from a trusted application (e.g., a word processor application). In other cases, pestware is obfuscated with encryption techniques so that a pestware file stored on a system hard drive may not be readily recognizable as a file that has spawned a pestware process. In yet other instances, pestware is known to be polymorphic in nature so as to change its size in memory or to change its starting address in memory.

Additionally, there may be activities that appear to be pestware related, but neither available software nor a typical user is able to identify, with sufficient certainty, the activity as being pestware-related activity. Accordingly, current software is not always able to identify and remove pestware in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as a method for managing pestware on a protected computer. The method in this embodiment includes monitoring the receipt of a file at the protected computer, monitoring processes created on the protected computer and identifying at least one of the processes as a process that is generated from the file. In addition, activity of the process is monitored and compared with factors indicative of pestware. The file and the process are then managed based upon the comparison of the activity of the process with the factors.

In another embodiment, the invention may be characterized as a method for managing pestware at a plurality of computers. The method in this embodiment includes collecting data from a plurality of computers that includes information about activities on each of the plurality of computers and establishing factors that correspond to patterns in the activities. In addition, weights are assigned to each of the factors based upon a comparison of the patterns with other patterns associated with both desirable and pestware applications so as to generate a plurality of weighted factors. The magnitude of the weight assigned to each of the factors is indicative of a likelihood that each of the factors is associated with pestware. The weighted factors are then sent to the plurality of computers so as to enable each of the plurality of computers to better manage pestware.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting an environment in which several embodiments of the invention may be implemented;

FIG. 2 is a block diagram depicting one embodiment of a protected computer; and

FIG. 3 is a flowchart depicting steps traversed in accordance with an exemplary embodiment of the present invention.

### DETAILED DESCRIPTION

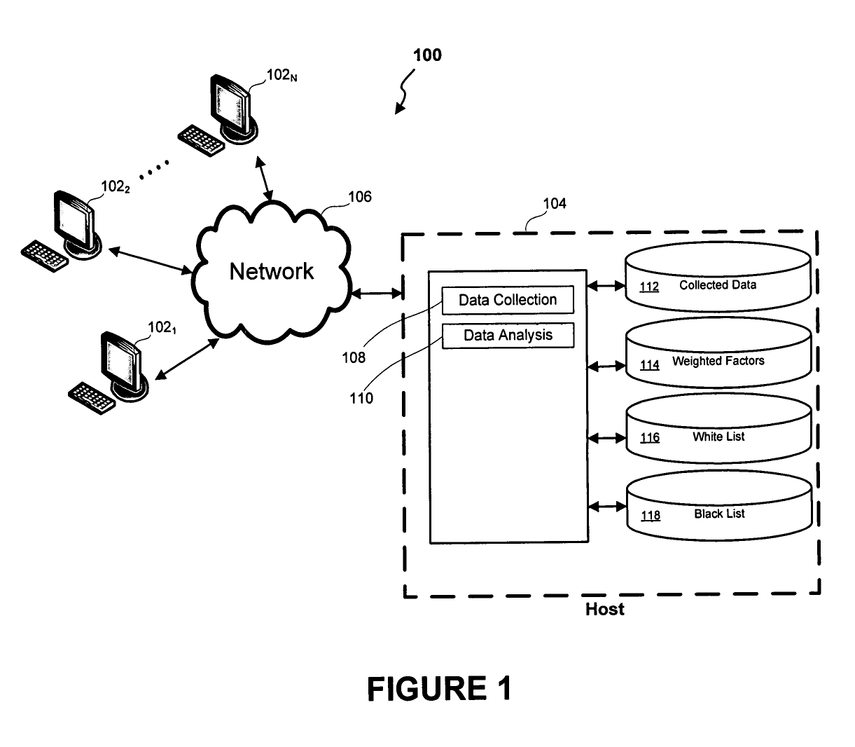

Referring now to the drawings, where like or similar elements are designated with identical reference numerals throughout the several views. Referring first to FIG. 1, shown is a block diagram depicting an environment 100 in which several embodiments of the present invention are implemented.

As shown, N protected computers 102_{1-N} are coupled to a host 104 via a network 106 (e.g., the Internet). The host 104 in this embodiment includes a data collection module 108 and a data analysis module 110. Also depicted are data storage devices 112-118 that include collected data 112, weighted factors 114, a white list 116 and a black list 118. The term “protected computer” is used herein to refer to any type of computer system, including personal computers, handheld computers, servers, firewalls, etc.

In accordance with several embodiments, each of the N protected computers 102_{1-N}provides data, via the network 106, about potential pestware activities on the computers 102_{1-N} to the host 104. The data collection module 108 in this embodiment collects the data from the protected computers 102_{1-N} and stores the data in the collected data storage 112. As discussed further herein, the data collected from the computers 102_{1-N} includes information about activities taking place on the protected computers 102_{1-N} that may be associated with pestware. In some variations, the data collection module 108 also scans the network 106 (e.g., utilizing bots) to identify and store the locations (e.g., URL or IP addresses) of sites that harbor pestware.

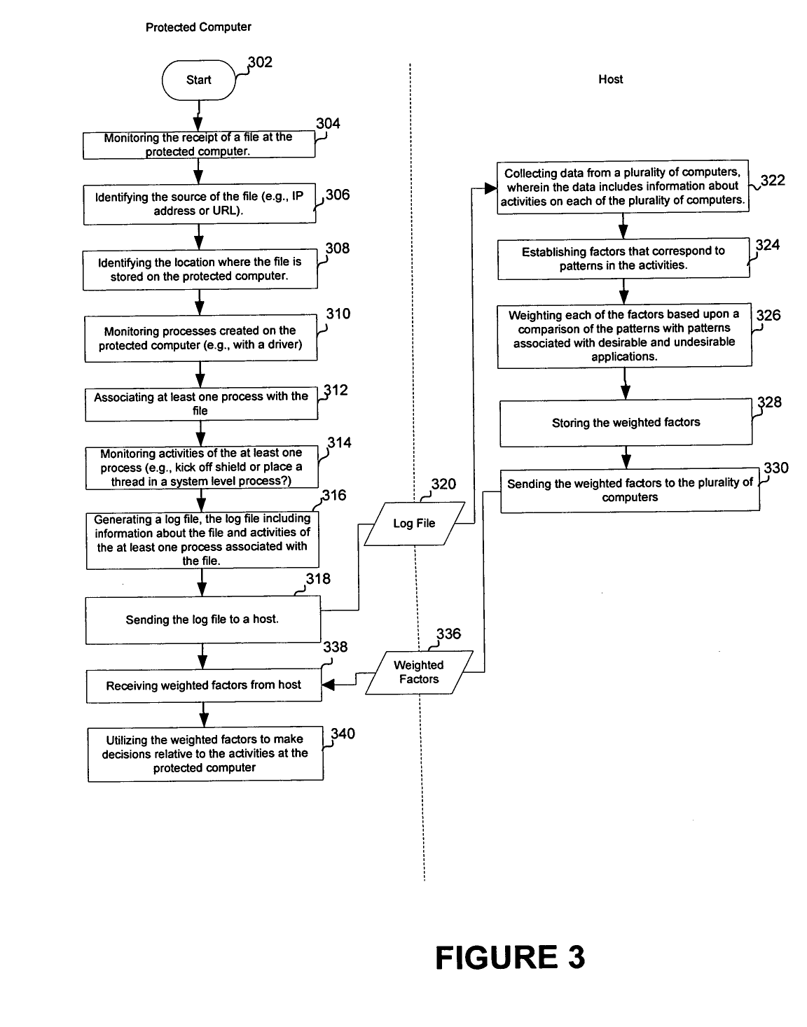

The data analysis module 110 in this embodiment is configured to analyze the collected data 112 in connection with data in the white list 116 and the black list 118 and to generate weighted factors that are subsequently used by the protected computers 102_{1-N} to help identify and manage pestware. As discussed further herein with reference to FIG. 3, the collected data 112 in several embodiments is analyzed against aspects of desirable applications in the white list 116 and pestware in the black list 118 so as to identify and weight factors that are indicative of a likelihood that the factor is associated with pestware. These weighted factors are stored and then sent to the protected computers 102_{1-N} where, as discussed further herein, the weighted factors are used to manage files and/or processes that may be pestware.

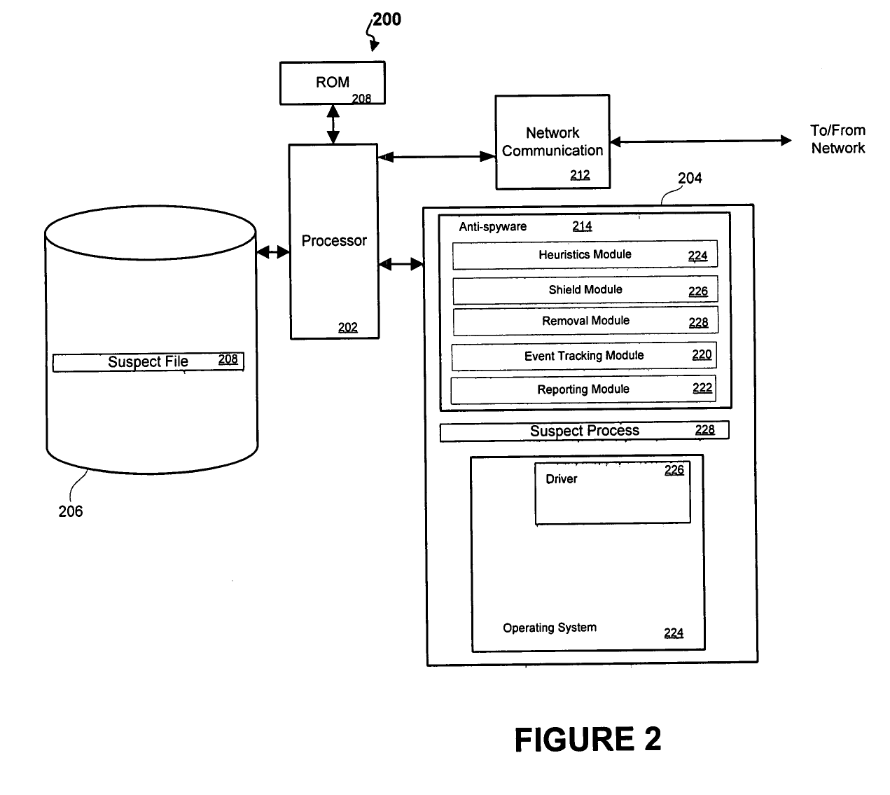

Referring next to FIG. 2, shown is a block diagram 200 of one embodiment of a protected computer 102_{1-N} depicted in FIG. 1. This implementation includes a processor 202 coupled to memory 204 (e.g., random access memory (RAM)), a file storage device 206, ROM 208 and network communication module 212.

As shown, the file storage device 206 provides storage for a collection files which includes a suspect file 208. The file storage device 206 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 206, which is depicted for convenience as a single storage device, may be realized by multiple (e.g., distributed) storage devices.

As shown, an anti-spyware application 214 includes a heuristics module 224, a shield module 226, a removal module 228, an event tracking module 220 and a reporting module 222 which are implemented in software and are executed from the memory 204 by the processor 202. In addition, a suspect process 228, an operating system 122 and a driver within the operating system 224 are also depicted as running from memory 204.

The anti-spyware application 214 can be configured to operate on personal computers (e.g., handheld, notebook or desktop), servers or any device capable of processing instructions embodied in executable code. Moreover, one of ordinary skill in the art will recognize that alternative embodiments, which implement one or more components in hardware, are well within the scope of the present invention.

Except as indicated herein, the operating system 224 is not limited to any particular type of operating system and may be operating systems provided by Microsoft Corp. under the trade name WINDOWS (e.g., WINDOWS 95, 98, 2000, NT and XP). Additionally, the operating system 122 may be an open source operating system such operating systems distributed under the LINUX trade name. For convenience, however, embodiments of the present invention are generally described herein with relation to WINDOWS-based systems. In light of the teaching disclosed herein, those of skill in the art can adapt these implementations for other types of operating systems or computer systems.

While referring to FIGS. 1 and 2, simultaneous reference will be made to FIG. 3, which depict steps traversed by the host 104 and protected computer 200 in accordance with an exemplary embodiment. As shown in FIG. 3, the receipt of files (e.g., from the network 106) is monitored at the protected computer 200 by the event tracking module 222 (Block 304). The files may be files that execute only when subsequently initiated (e.g., files ending in a .exe extension) or may be immediately executable files (e.g., Java applets or ActiveX controls). As shown in FIG. 2, the source of the file (e.g., IP address or URL) is also identified (Block 306). The above-identified application entitled System and Method for Monitoring Network Communications for Pestware discloses techniques for monitoring network activity and identifying the source of a file. In addition, the location where the file (e.g., the suspect file 208) is stored is identified and maintained along with the source of the file (Block 308).

In addition to files that are received, each process that is launched (e.g., the suspect process 228) is also monitored (Block 310) and associated with the file that spawned the process (e.g., the suspect file 208)(Block 312). As depicted in FIG. 2, a driver 226, which is incorporated with the operating system 224, is configured to identify processes as they are created and to report the creation of each process to the event tracking module 220. In this way, a history of each process and each file that spawned each process is known. In addition, the driver 226 may be configured to identify system calls directed at hooking into the operating system of the protected computer 224.

As shown in the exemplary embodiment of FIG. 3, activities associated with processes (e.g., the suspect process 228) on the protected computer 200 are also monitored (Block 314). For example, the shield module 226 in connection with the event tracking module 220 in the exemplary embodiment tracks activities that may include: a process trying to change a home page and/or bookmarks of a browser, a process communicating with particular remote sites via the Internet and a process making additions to a startup folder and/or changing registry entries of the protected computer 200.

In addition, network activity is monitored for indications of activities associated with a suspect process (e.g., the suspect process 228). As another example the process may spawn another process and/or may inject a DLL into another process. In some instances, processes are known to spawn threads within desirable system level processes. The above identified application entitled: System and Method for Removing Pestware in System-Level Processes and Executable Memory discloses techniques for identifying system-level threads that are spawned by other processes.

As yet another example, the driver 226 may monitor activities that relate to system-level calls or attempts to place hooks into the operating system. The driver 226 may also monitor for any attempts to alter certain system files. For example, the driver 226 may be configured to monitor attempts to change or replace one or more drivers (e.g., a keyboard driver). In variations, the driver 226 may be configured to monitor pestware that is capable of altering files (e.g., system-level files) without using the operating system 224.

In accordance with several embodiments, the data is gathered by the reporting module 222 (as described with reference to Blocks 306-314) and assembled into a log file 320 (Block 316) that is sent to the host 104 (Block 318). In some embodiments, the log file 320 is sent at the request of the user (e.g., when the user suspects pestware is present), and in other embodiments, the reporting module 222 is configured to automatically send the log file 320 to the host 104 (e.g., in response to a shield in the shield module 226 being triggered).

As depicted in FIG. 3, the host 104 collects data from the plurality of computers 102_{1-N} (Block 322). Although FIG. 3 depicts the host 104 receiving a log file 320 generated from data obtained from steps described with reference to Blocks 304-316, it should be recognized that in other embodiments the host 104 may receive data that only includes a portion of the history collected in Blocks 304-316.

As shown in FIG. 3, once the host 104 collects data about activities on the computers 102_{1-N}, the data analysis module 110 of the host 104 establishes factors that correspond to patterns in the activities (Block 324). For example, patterns may appear in the specific activities that are occurring together and/or the amount of time that transpires between one or more activities. As another example, a pattern may emerge that connects a file that is stored at a certain location on a hard drive with particular processes that are associated with particular changes to the startup folder or registry entries.

As depicted in FIG. 3, each of the factors are weighted based upon a comparison of the patterns in the data from the protected computers 102_{1-N} with patterns associated with desirable applications in the white list 116 and pestware applications in the black list 118 (Block 326). In several embodiments for example, heavier weights are placed on factors known to be associated with pestware. In some implementations, Bayesian techniques are utilized to generate the weighted factors, but this is certainly not required. As depicted in FIG. 3, the weighted factors 336 are stored in a weighted factor database 114 (Block 328), and are sent via the network 106 to the protected computers 102_{1-N} (Blocks 330, 332).

In accordance with several embodiments of the present invention, the weighted factors 336 are utilized by the heuristics module 224 to make decisions relative to activities at the protected computer (Block 340). In some embodiments for example, Blocks 304 to 314 are carried out on an ongoing basis to gather a history of activities on the protected computer 200, and the activity history is then compared to the weighted factors 336 so as to match the activities in the history to the weighted factors 336. If the sum of the weighted factors that match the activity history exceed a threshold, then the activity is identified as potential pestware activity and a user of the protected computer 200 is provided with information about the potential pestware activity.

In some embodiments for example, the user is provided with information about the source of a file (e.g., a source of the suspect file 208) (e.g., a URL) and information about the activities that process(es) (e.g., the suspect process 228) have been carrying out (e.g., attempts to change a home page of the browser) so that the user may make a more informed decision about whether or not to quarantine and/or remove the suspected pestware.

In variations, multiple thresholds are utilized to manage pestware at the protected computer. For example, if the sum of the weighted factors exceeds a first threshold, the user is merely notified of the potential pestware activity and activities at the protected computer continue to be monitored. If, however, the sum of the weighted factors associated with an activity at the protected computer exceeds a second threshold, then the activity is automatically blocked.

In some of these embodiments, a user of the protected computer is able to vary the threshold by selecting a level of desired safety (e.g., from maximum to minimum). In these embodiments, the higher the level of protection the user desires, the lower the level of the threshold that is established. Additionally, the user in some variations is also able to select whether potential pestware is automatically removed once the threshold is reached.

In conclusion, the present invention provides, among other things, a system and method for managing pestware by gathering information about activities on a protected computer and comparing the activities with factors associated with pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing pestware on a protected computer comprising:
monitoring the receipt of a file at the protected computer;
monitoring processes created on the protected computer;
identifying at least one of the processes as a process that is generated from the file;
monitoring activity of the process;
comparing activity of the process with factors indicative of pestware;
managing the file and the process based upon the comparison of the activity of the process with the factors.

2. The method of claim 1, wherein the file is an immediately executable file selected from the group consisting of an ActiveX control and a Java applet.

3. The method of claim 1, including:
identifying the source of the file received at the protected computer, wherein the comparing includes comparing the source of the of the file with the factors indicative of pestware.

4. The method of claim 3, wherein the identifying the source of the file includes identifying an IP address or a URL.

5. The method of claim 3 including identifying the location where the file is stored on the protected computer wherein the comparing includes comparing the location where the file is stored on the protected computer with the factors indicative of pestware.

6. The method of claim 1 including generating a log file, the log file including information about the file and activities of the process that is generated from the file.

7. The method of claim 1, wherein the factors are weighted factors, and wherein the weighted factors are generated based upon pestware activities on a plurality of computers.

8. The method of claim 1, wherein monitoring activity of the process includes monitoring activities selected from the group consisting of: spawning another process, altering registry entries, initiating communications with remote sites via the Internet, altering a start up folder, injecting a DLL into another process, changing a home page and changing bookmarks.

9. The method of claim 1, wherein comparing includes comparing activity of the process with weighted, factors, the weighted factors being weighted based upon a likelihood the factor is associated with pestware.

10. The method of claim 1, wherein managing includes neutralizing the process in response to the activity of the process matching at least two of the factors, wherein a sum of weights assigned to each of the at least two factors exceeds a threshold.

11. The method of claim 1, wherein the threshold is established by a user of the protected computer.

12. The method of claim 1, including:
providing, based upon the comparison of the activity of the at least one process with the factors, information to the user about the process.

13. A method for managing pestware at a plurality of computers comprising:
collecting data from a plurality of computers, wherein the data includes information about activities on each of the plurality of computers;
establishing factors that correspond to patterns in the activities;
assigning a weight to each of the factors based upon a comparison of the patterns with other patterns associated with both desirable and pestware applications so as to generate a plurality of weighted factors, wherein a magnitude of the weight assigned to each of the factors is indicative of a likelihood that each of the corresponding factors is associated with pestware; and
sending the weighted factors to the plurality of computers.

14. The method of claim 13, wherein the activities are selected from the group consisting of: spawning another process, altering registry entries, initiating communications with remote sites via the Internet, altering a start up folder, injecting a DLL into another process, changing a home page and changing bookmarks.

15. A computer readable medium encoded with instructions to manage pestware on a protected computer, the instructions including instructions for:
monitoring the receipt of a file at the protected computer;
monitoring processes created on the protected computer;
identifying at least one of the processes as a process that is generated from the file;
monitoring activity of the process;
comparing activity of the process with factors indicative of pestware;
managing the file and the process based upon the comparison of the activity of the process with the factors.

16. The computer readable medium of claim 15, including instructions for:
identifying the source of the file received at the protected computer, wherein the comparing includes comparing the source of the of the file with the factors indicative of pestware.

17. The computer readable medium of claim 16 including instructions for identifying the location where the file is stored on the protected computer wherein the instructions for comparing includes instructions for comparing the location where the file is stored on the protected computer with the factors indicative of pestware.

18. The computer readable medium of claim 15 including instructions for generating a log file, the log file including information about the file and activities of the process that is generated from the file.

19. The computer readable medium of claim 15, wherein the factors are weighted factors, and wherein the weighted factors are generated based upon pestware activities on a plurality of computers.

20. The computer readable medium of claim 15, wherein the instructions for monitoring activity of the process includes instructions for monitoring activities selected from the group consisting of: spawning another process, altering registry entries, initiating communications with remote sites via the Internet, altering a start up folder, injecting a DLL into another process, changing a home page and changing bookmarks.

21. The computer readable medium of claim 15, wherein the instructions for comparing includes instructions for comparing activity of the process with weighted factors, the weighted factors being weighted based upon a likelihood the factor is associated with pestware.

22. The computer readable medium of claim 15, wherein the instructions for managing includes instructions for neutralizing the process in response to the activity of the process matching at least two of the factors, wherein a sum of weights assigned to each of the at least two factors exceeds a threshold.

23. The computer readable medium of claim 15, wherein the threshold is established by a user of the protected computer.

24. The computer readable medium of claim 15, including instructions for:
providing, based upon the comparison of the activity of the process with the factors, information to the user about the process.
